(19) United States
(12) Patent Application Publication
(10) Pub. No.: US 2026/0055123 A1
(43) Pub. Date: Feb. 26, 2026

(54) PROCESS FOR THE PREPARATION L-GLUFOSINATE OR SALTS THEREOF

(71) Applicant: UPL Limited, Mumbai (IN)

(72) Inventors: Prashant Kini, Thane (W) (IN); Chandrasekhar Dayal Mudaliar, Thane (W) (IN); Ashishkumar Ravindra Mishra, Thane (W) (IN); Sandeep Khandu Thakare, Thane (W) (IN)

(21) Appl. No.: 19/304,841

(22) Filed: Aug. 20, 2025

(30) Foreign Application Priority Data
Aug. 20, 2024 (IN) 202421062811

(51) Int. Cl. C07F 9/30; A01N 57/20; A01P 13/00

(52) U.S. Cl. CPC C07F 9/301; A01N 57/20; A01P 13/00

(57) ABSTRACT

The present invention relates to a process for preparation of L-glufosinate salt. The present invention more particularly relates to a process for preparation of an aqueous solution of L-glufosinate salt, substantially free of impurities.

### CROSS REFERENCE TO RELATED APPLICATION

This application claims the benefit of Indian Application No. 202421062811, filed Aug. 20, 2024, which is incorporated by reference in its entirety herein.

### FIELD OF THE INVENTION

The present invention relates to a process for preparation of L-glufosinate salt. The present invention more particularly relates to a process for preparation of an aqueous solution of L-glufosinate salt, substantially free of impurities.

### BACKGROUND OF THE INVENTION

Glufosinate is a non-selective contact herbicide which acts as a Glutamine synthetase inhibitor. Glufosinate is sold commercially as a racemic mixture of D- and L-phosphinothricin. However, only the L-isomer has herbicidal activity.

There are various methods reported in the literature to prepare L-glufosinate or its salt. This includes asymmetric chemical synthesis, by chiral separation as well as biocatalytic methods. Chemical methods include the ones which employs stereospecific raw materials to get L-glufosinate; whereas biocatalytic methods employ micro-organisms or specific enzyme/s for converting racemic glufosinate or other intermediates such as PPO (2-oxo-4-(hydroxy(methyl)phosphinoyl)butyric acid) to L-glufosinate.

U.S. Pat. No. 5,442,088, hereinafter referred to as “the '088 patent” discloses a chemical method for preparation of L-glufosinate wherein optically active L-homoserine lactone is converted to corresponding glufosinate ester which on hydrolysis provide L-glufosinate or its salt.

The chemical methods has a drawback of generating large amounts of inorganic and organic impurities; and requires removal of these impurities to get L-glufosinate or its salt.

Another method largely used for preparation of L-glufosinate or aqueous solution of L-glufosinate or its salt is the biocatalytic method. The biocatalytic method employs racemic glufosinate as the starting material which undergoes multistep reactions involving the use of amine donors, and/or amine acceptors in equimolar quantities, multiple enzymes, co-enzymes, catalysts, whole cell catalysts etc. The final composition obtained by biocatalytic processes may comprise unreacted starting materials such as D-glufosinate, intermediates such as (2-oxo-4-(hydroxy(methyl)phosphinoyl)butyric acid) (PPO), unreacted amine donors, the corresponding ketonic by-products in equimolar quantities and other bio-wastes such as cells and enzymes, some of which may be of toxicological concern. To isolate L-glufosinate from this reaction mixture is tedious, non-ecofriendly and hence not commercially viable.

In view of the above problems, there still exists a need of a cost effective, hassle-free process to prepare L-glufosinate or its salts which eliminates the drawbacks of the prior art processes.

### OBJECT OF THE INVENTION

Accordingly, the object of the present invention is to provide a process for the preparation of an aqueous solution of L-glufosinate.

Yet another object of the present invention is to provide an aqueous solution of L-glufosinate which is substantially free of impurities.

Yet another object of the present invention is to provide a highly pure L-glufosinate hydrochloride.

### SUMMARY OF INVENTION

In an aspect of the present invention, there is provided a process for obtaining L-glufosinate acid addition salt having purity of at least 90%, comprising treating crude L-glufosinate acid addition salt with water, alcohol or mixtures thereof.

In an aspect of the present invention, there is provided a process for obtaining L-glufosinate hydrochloride having purity of at least 90%, comprising treating crude L-glufosinate hydrochloride with water, alcohol or mixtures thereof.

In an aspect of the present invention there is provided a process for preparation of an aqueous solution of L-glufosinate salt.

In an aspect of the present invention there is provided a process for preparation of an aqueous solution of L-glufosinate salt, comprising the steps of;
i. obtaining L-glufosinate hydrochloride having purity of at least 90%, and
ii. converting said hydrochloride to aqueous solution containing at least 15% of L-glufosinate salt by treatment with a base.

In an aspect of the present invention there is provided a process for preparation of an aqueous solution of L-glufosinate salt comprising steps of,
i. obtaining L-glufosinate hydrochloride having purity of at least 90%;
ii. converting said hydrochloride to aqueous solution containing at least 15% of L-glufosinate salt by treatment with a base;
   wherein said aqueous solution of L-glufosinate salt is substantially free of impurities.

In an aspect of the present invention there is provided a process for preparation of an aqueous solution of L-glufosinate salt comprising steps of,
i. obtaining L-glufosinate hydrochloride having purity of at least 90%;
ii. converting said hydrochloride salt to L-glufosinate acid followed by treatment with base to obtain aqueous solution containing at least 15% of L-glufosinate r salt;
   wherein said aqueous solution of L-glufosinate salt is substantially free of impurities.

In another aspect of the present invention there is provided use of an aqueous solution of L-glufosinate salt for the preparation of an agrochemical composition.

In another aspect of the present invention, there is provided an agrochemical composition comprising an aqueous solution of L-glufosinate salt and at least one agrochemically acceptable excipient.

In another aspect of the present invention, there is provided a process for preparing an agrochemical composition comprising an aqueous solution of L-glufosinate salt and at least one agrochemically acceptable excipient,
the process comprising:
   i. preparing an aqueous solution containing at least 15% of L-glufosinate salt according to present invention,
   ii. adding at least one agrochemical acceptable excipient in the aqueous solution of step (i),
   iii. homogenizing the mixture obtained in step (ii) to get said agrochemical composition.

### DETAILED DESCRIPTION OF THE INVENTION

In order to provide a clear and consistent understanding of the terms used in the present specification, a number of definitions are provided below. Moreover, unless defined otherwise, all technical and scientific terms as used herein have the same meaning as commonly understood by the person of ordinary skill in the art to which this invention pertains.

As used in this specification the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

### Definitions

The term ‘impurities’ refers to unreacted synthetic intermediates, reagents, organic and/or inorganic by-products of side chemical reactions.

The term “substantially free of impurities” refers to L-glufosinate or salts thereof having less than 10% of the impurities, preferably less than 5% of the impurities.

The term “aqueous solution” refers to the aqueous solution of L-glufosinate salt having at least 15% concentration.

As used in the present invention, the term “aqueous solution” is alternately referred to as “MUP” having at least 15% w/w L-glufosinate salt.

The term “Manufacturing Use Product” is used interchangeably as “MP” or “MUP”. Manufacturing Use Product is any pesticide product other than an end use product.

The term “crude L-glufosinate hydrochloride” refers to wet cake of L-glufosinate hydrochloride with residual solvents and having purity not more than 85%.

The term “L-glufosinate salt” includes the salts of L-glufosinate such as monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺ salt, —NH(CH₃)₂(C₂H₄OH)⁺ salt, and —NH₂(CH₃)(C₂H₄OH)⁺ salt are included in the definition.

The term “room temperature” unless stated otherwise, refers to the temperature in the range of about 25° C. to about 35° C.

The agronomically acceptable salts include L-glufosinate-ammonium, L-glufosinate-sodium, and L-glufosinate-potassium. The term may also refer to an isomeric mixture of L-glufosinate, D-glufosinate and salts thereof, wherein the content of L-glufosinate in the mixture is 70% or greater, preferably 80% or greater and more preferably 90% or greater. Typically, the ratio of L-glufosinate: D-glufosinate can be in the range from about 90:10 to about 100:0, preferably from about 95:5 to about 100:0.

Accordingly, the present invention is now described in connection with certain embodiments of the invention which will be apparent to the person skilled in the art from the examples provided herewith.

In an embodiment, the present invention provides a process for obtaining L-glufosinate acid addition salt having purity of at least 90%, comprising treating crude L-glufosinate acid addition salt with water, an alcohol, or mixtures thereof.

In a subsequent embodiment, L-glufosinate acid addition salt is prepared by hydrolysis of compound of Formula (II) in presence of an acid, to give L-glufosinate acid addition salt of Formula (I);

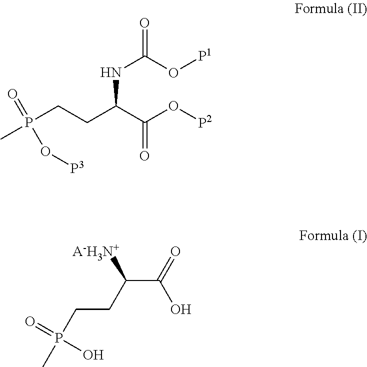

wherein, P¹ is selected from group comprising of substituted or unsubstituted C₁ to C₁₀ alkyl group; acyl group such as C(═O)Y, wherein Y can be OR or R, wherein R is substituted or unsubstituted C₁ to C₁₀ alkyl group, a substituted or unsubstituted C₁ to C₁₀ alkenyl group, a substituted or unsubstituted C₁ to C₁₀ alkynyl group, a substituted or unsubstituted C₃ to C₁₀ cycloalkyl group, a substituted or unsubstituted C₆ to C₂₀ aryl group, or a substituted or unsubstituted C₂ to C₁₀ heteroaryl group; or urea, urethane, nitroso, nitro, sulphenyl, sulphonyl, sulfonic acid, or trialkylsilyl. Examples include acetyl, carbobenzyloxy (also benzyloxycarbonyl or carbobenzoxy), formyl, t-butyloxycarbonyl, fluorenylmethyloxycarbonyl, 2-nitrophenylsulfenyl, methanesulfonyl, p-toluenesulfonyl, or p-nitro phenyl sulfonyl group;
P² is selected from group comprising of substituted or unsubstituted C₁ to C₁₀ alkyl group; substituted or unsubstituted C₁ to C₁₅ acyl group derived from mono or dicarboxylic acid; —CORα, wherein Rα is selected from substituted or unsubstituted C₁ to C₁₅ alkyl, C₁ to C₁₅ alkenyl, C₁ to C₁₅ alkyne, C₆ to C₂₀ aryl and aralkyl groups; —SO₃H group; —SO₂Rb wherein Rb is selected from substituted or unsubstituted C₁ to C₁₅ alkyl, aryl and aralkyl groups; silyl group —SiRcRdRe wherein Rc, Rd, Re may be the same or different and are selected from the group consisting of C₁-C₆ alkyl, aryl and aralkyl groups, —(CH2)nO-Rc wherein Rc is selected from the group consisting of C₁-C₆ alkyl, aryl and aralkyl groups or a tetrahydropyranyl; 0-trifluoromethyl sulfonyl (triflates); or O-trifluoromethyl acetyl;
P³ is selected from hydrogen; substituted or unsubstituted C₁ to C₁₀ alkyl group; substituted or unsubstituted C₁ to C₁₀ alkenyl group, a substituted or unsubstituted C₁ to C₁₀ alkynyl group, a substituted or unsubstituted C₃ to C₁₀ cycloalkyl group, a substituted or unsubstituted C₆ to C₂₀ aryl group;
A⁻ is the anion, selected from halides such as chloride or bromide; phosphates, sulphates or acetates.

In another embodiment, the acid addition salt of compound of Formula (I) is formed by reacting L-glufosinate and an acid selected from an inorganic acid or an organic acid such as hydrochloric acid, sulfuric acid, phosphoric acid and acetic acid.

In an embodiment the acid addition salt of L-glufosinate is selected from L-glufosinate hydrochloride, L-glufosinate hydrobromide, L-glufosinate phosphate, L-glufosinate sulphate or L-glufosinate acetate.

In an embodiment the acid addition salt of L-glufosinate is L-glufosinate hydrochloride salt.

In an embodiment, the compound of Formula (II) is ethyl (2S)-2-[(ethoxy carbonyl)amino]-4-[ethoxy(methyl)phosphoryl]butanoate.

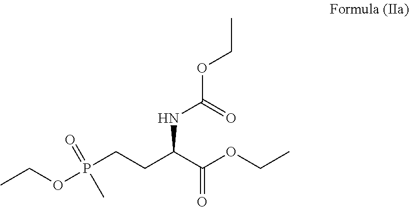 [SMILES: CCOC(=O)N[C@H](CCP(C)(=O)OCC)C(=O)OCC]

In an embodiment, the present invention provides a process for obtaining L-glufosinate hydrochloride having purity of at least 90%, comprising, treating crude L-glufosinate hydrochloride with water, alcohol or mixtures thereof.

In an embodiment, L-glufosinate hydrochloride is prepared by hydrolysis of ethyl (2S)-2-[(ethoxy carbonyl)amino]-4-[ethoxy(methyl)phosphoryl]butanoate of Formula (IIa),

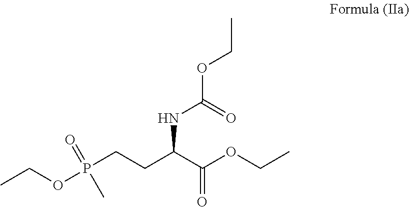 [SMILES: CCOC(=O)N[C@H](CCP(C)(=O)OCC)C(=O)OCC]

in presence of hydrochloric acid, to give crude L-glufosinate hydrochloride of Formula (Ia), having a purity not more than 85%

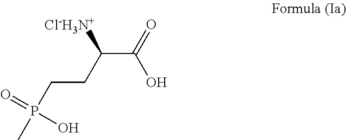

In an embodiment, crude L-glufosinate hydrochloride is treated with water, alcohol or mixture thereof to obtain L-glufosinate hydrochloride having purity of at least 90%.

In an embodiment, the process for obtaining L-glufosinate hydrochloride having purity of at least 90% comprises steps of:
i) hydrolysis of ethyl (2S)-2-[(ethoxy carbonyl)amino]-4-[ethoxy(methyl)phosphoryl]butanoate of Formula (IIa),

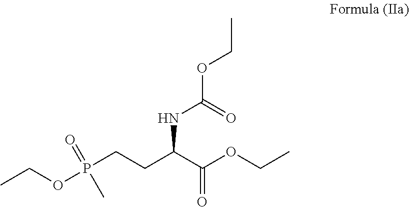 [SMILES: CCOC(=O)N[C@H](CCP(C)(=O)OCC)C(=O)OCC]

in presence of hydrochloric acid to obtain crude L-glufosinate hydrochloride of Formula (Ia) having purity of not more than 85%

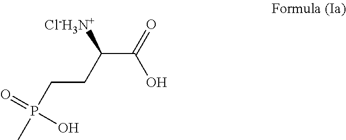

ii) treating crude L-glufosinate hydrochloride of Formula (Ia) obtained in step i) with water, alcohol or mixture thereof to obtain L-glufosinate hydrochloride having purity of at least 90%.

In an embodiment, in step (i), hydrolysis of ethyl (2S)-2-[(ethoxy carbonyl)amino]-4-[ethoxy(methyl)phosphoryl]butanoate of Formula (IIa) is carried out at 80° C. to 150° C.

In an embodiment, in step (i), hydrolysis of ethyl (2S)-2-[(ethoxy carbonyl)amino]-4-[ethoxy(methyl)phosphoryl]butanoate of Formula (IIa) is carried out at 110° C. to 130° C.

In an embodiment, L-glufosinate hydrochloride solution after hydrolysis is subjected to distillation to remove acidic water from the reaction mass.

In an embodiment crude L-glufosinate hydrochloride obtained after distillation in step (i) is having purity of 75% to 85%.

In a subsequent embodiment, in step (ii), crude L-glufosinate hydrochloride is treated with water, alcohol or mixture thereof to obtain L-glufosinate hydrochloride having purity of at least 90%.

In a preferred embodiment, crude L-glufosinate hydrochloride obtained after hydrolysis reaction is sequentially treated with water and alcohol respectively, to obtain L-glufosinate hydrochloride having purity of at least 90%.

In an embodiment, the crude L-glufosinate hydrochloride obtained after hydrolysis reaction is treated with mixture of water and alcohol to obtain L-glufosinate hydrochloride having purity of at least 90%.

In an embodiment the mixture of water and alcohol is used in a ratio of water: alcohol 1 to 100:100 to 1.

In an embodiment, the alcohol is selected from methanol, ethanol, 1-propanol, iso-propanol, n-butanol or tertiary butanol, preferably ethanol is used.

In another embodiment, in step (ii), treatment of crude L-glufosinate hydrochloride with water, alcohol or mixtures thereof is carried out at 40° C. to 80° C., preferably at 50° C. to 70° C.

In yet another embodiment, crude L-glufosinate hydrochloride obtained after hydrolysis reaction may be treated with an organic solvent.

In another embodiment, the organic solvent is a water immiscible solvent.

In an embodiment, the water immiscible solvent is selected from halogenated aliphatic hydrocarbon solvent such as dichloromethane, dichloroethane, carbon tetrachloride; aromatic hydrocarbon solvent such as toluene, xylene, benzene, monochlorobenzene; or mixture thereof.

In another embodiment, crude L-glufosinate hydrochloride that is obtained after hydrolysis reaction may be subjected to activated carbon treatment.

In another embodiment, L-glufosinate hydrochloride obtained in step (ii) is at least 90% pure.

In another embodiment, L-glufosinate hydrochloride obtained in step (ii) is at least 95% pure.

In another embodiment wet cake of L-glufosinate hydrochloride having purity of at least 90% is used as such for next step.

In an alternate embodiment wet cake of L-glufosinate hydrochloride having purity of at least 90% is dried and then taken for next step.

In an embodiment, the present invention provides a process for preparation of an aqueous solution of L-glufosinate salt.

In an embodiment, the present invention provides a process for preparation of an aqueous solution of L-glufosinate salt, comprising the steps of:
i) obtaining L-glufosinate hydrochloride having purity of at least 90%; comprising steps of:
   a. hydrolysis of ethyl (2S)-2-[(ethoxy carbonyl)amino]-4-[ethoxy(methyl)phosphoryl]butanoate in presence of hydrochloric acid to obtain crude L-glufosinate hydrochloride of Formula (Ia) having purity of not more than 85%,
   b. treating crude L-glufosinate hydrochloride obtained in step a) with water, alcohol or mixture thereof at 40° C. to 80° C. to obtain L-glufosinate hydrochloride having purity of at least 90%,
ii) converting said hydrochloride to aqueous solution of L-glufosinate salt; comprising steps of:
   treating L-glufosinate hydrochloride with an alkylene oxide to obtain corresponding acid; followed by treatment with base and water to obtain aqueous solution of L-glufosinate salt

In another embodiment, step ii) of converting L-glufosinate hydrochloride to an aqueous solution of L-glufosinate salt comprises treating L-glufosinate hydrochloride with a base followed by a step of separation/purification by way of filtration; wherein filtration is carried out by using a nanomembrane.

In another embodiment, the present invention provides a process for preparation of an aqueous solution of L-glufosinate salt, comprising the steps of,
i. obtaining L-glufosinate hydrochloride having purity of at least 90%; and
ii. converting said hydrochloride to aqueous solution containing at least 15% of L-glufosinate salt by treatment with a base.

In accordance with the step (i) of above embodiment, L-glufosinate hydrochloride used in the present invention may be prepared by known method.

In another embodiment, L-glufosinate hydrochloride obtained is at least 90% pure and further comprises not more than 10% alcoholic solvents and water.

In another embodiment, L-glufosinate hydrochloride obtained is at least 93% pure and further comprises not more than 7% of alcoholic solvents and water.

In another embodiment, L-glufosinate hydrochloride obtained is at least 95% pure and further comprises not more than 5% of alcoholic solvents and water.

In yet another embodiment, L-glufosinate hydrochloride obtained contains at least 5% of water.

In yet another embodiment, L-glufosinate hydrochloride obtained contains at least 2% of water.

In a preferred embodiment, L-glufosinate hydrochloride having at least 2% to 5% of water content is used in subsequent steps. This eliminates the drying operation during the process which helps to save the process cost and reduce the process cycle time. Optionally, L-glufosinate hydrochloride may be used after drying.

In another embodiment, in step (ii), L-glufosinate hydrochloride having purity of at least 90% is converted to aqueous solution containing at least 15% L-glufosinate salt by treatment with a base.

In an embodiment, the base used in step (ii) is selected from the group comprising of alkali hydroxide; alkali metal carbonate, bicarbonate; ammonia.

In an embodiment, the base is an inorganic base. the inorganic base is selected from alkali hydroxide, such as potassium hydroxide and sodium hydroxide or alkali metal carbonate such as, potassium carbonate, sodium carbonate, ammonium carbonate, potassium bicarbonate, sodium bicarbonate, or ammonia in aqueous or gaseous form.

In an embodiment L-glufosinate salt prepared according to the present invention is L-glufosinate ammonium or L-glufosinate sodium.

In an embodiment, present invention provides a process for preparation of an aqueous solution of L-glufosinate salt, comprising the steps of:
i. obtaining L-glufosinate hydrochloride having purity of at least 90%; comprising steps of:
   a) hydrolysis of ethyl (2S)-2-[(ethoxy carbonyl)amino]-4-[ethoxy(methyl)phosphoryl]butanoate of Formula (IIa),

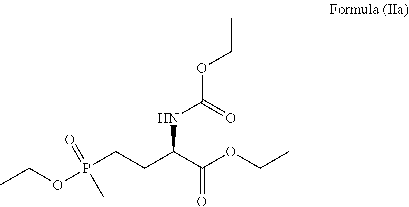 [SMILES: CCOC(=O)N[C@H](CCP(C)(=O)OCC)C(=O)OCC]

in presence of hydrochloric acid to obtain crude L-glufosinate hydrochloride of Formula (Ia) having purity of not more than 85%,

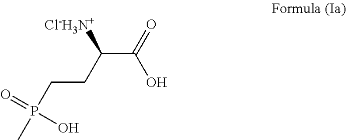

b) treating crude L-glufosinate hydrochloride of Formula (Ia) obtained in step (i) with water, alcohol or mixture thereof to obtain L-glufosinate hydrochloride having purity of at least 90%,
ii. converting said hydrochloride to aqueous solution containing at least 15% of L-glufosinate salt by treatment with a base.

In another embodiment, the present invention provides the process for preparation of an aqueous solution of L-glufosinate salt comprising steps of
i. obtaining L-glufosinate hydrochloride having purity of at least 90%;
ii. converting said hydrochloride to aqueous solution containing at least 15% of L-glufosinate salt by treatment with a base;
   wherein said aqueous solution of L-glufosinate salt is substantially free of impurities.

In an embodiment, at least 15% aqueous solution or MUP solution of L-glufosinate salt thereof is prepared according to the preferred embodiments of the present invention, wherein said aqueous solution is substantially free of impurities.

In an embodiment, at least 30% aqueous solution or MUP solution of L-glufosinate salt is prepared wherein said aqueous solution is substantially free of impurities.

In an embodiment, at least 40% aqueous solution or MUP solution of L-glufosinate salt is prepared wherein said aqueous solution is substantially free of impurities.

In an embodiment at least 50% aqueous solution or MUP solution of L-glufosinate salt is prepared wherein said aqueous solution is substantially free of impurities.

In an embodiment, the concentration of aqueous solution or MUP solution of L-glufosinate salt can be adjusted as per requirement.

In another embodiment the present invention provides the process for preparation of an aqueous solution of L-glufosinate salt comprising steps of
i. obtaining L-glufosinate hydrochloride having purity of at least 90%;
ii. converting said hydrochloride to L-glufosinate acid using alkylene oxide followed by treatment with base and water to obtain aqueous solution containing at least 15% of L-glufosinate salt;
   wherein said aqueous solution of L-glufosinate salt is substantially free of impurities.

In an embodiment, in step (ii) L-glufosinate hydrochloride is first converted to corresponding L-glufosinate acid by treating L-glufosinate hydrochloride with an alkylene oxide; followed by treatment with base to obtain aqueous solution of L-glufosinate salt.

In an embodiment, the alkylene oxide such as, ethylene oxide, propylene oxide, epichlorohydrin or 1,2-Epoxycyclohexane is used; preferably propylene oxide is used.

In a subsequent embodiment, the treatment of L-glufosinate hydrochloride with alkylene oxide is carried out at temperature ranging from 0° C. to 100° C., preferably at temperature ranging from 0° C. to 50° C.

In an embodiment, the treatment of L-glufosinate hydrochloride with alkylene oxide is carried out in presence of water, an alcohol, or mixture thereof.

In an embodiment, the alcohol used is selected from methanol, ethanol, 1-propanol, iso-propanol, isopropanol, n-butanol or tertiary butanol, preferably ethanol is used.

In another embodiment, the reaction mass after treatment with alkylene oxide is subjected to treatment with base and water to get at least 15% aqueous solution of L-glufosinate salt.

In an embodiment, present invention provides a process for preparation of an aqueous solution of L-glufosinate ammonium, comprising the steps of,
i) obtaining L-glufosinate hydrochloride having purity of at least 90%; comprising steps of:
   a. hydrolysis of ethyl (2S)-2-[(ethoxy carbonyl)amino]-4-[ethoxy(methyl)phosphoryl]butanoate in presence of hydrochloric acid to obtain crude L-glufosinate hydrochloride of Formula (Ia) having purity of not more than 85%,
   b. treating crude L-glufosinate hydrochloride obtained in step a) with water, alcohol or mixture thereof at 40° C. to 80° C. to obtain L-glufosinate hydrochloride having purity of at least 90%,
ii) converting said hydrochloride to aqueous solution of L-glufosinate ammonium;
comprising steps of:
   treating L-glufosinate hydrochloride with an propylene oxide in ethanol to obtain corresponding acid; followed by treatment with ammonia and water to obtain aqueous solution of L-glufosinate ammonium.

In an embodiment, present invention provides a process for preparation of an aqueous solution of L-glufosinate ammonium, comprising the steps of,
i) obtaining L-glufosinate hydrochloride having purity of at least 90%; comprising steps of:
   a. hydrolysis of ethyl (2S)-2-[(ethoxy carbonyl)amino]-4-[ethoxy(methyl)phosphoryl]butanoate in presence of hydrochloric acid to obtain crude L-glufosinate hydrochloride of Formula (Ia) having purity of not more than 85%,
   b. treating crude L-glufosinate hydrochloride obtained in step a) with water, alcohol or mixture thereof at 40° C. to 80° C. to obtain L-glufosinate hydrochloride having purity of at least 90%,
ii) converting said hydrochloride to aqueous solution of L-glufosinate ammonium;
comprising steps of:
   treating L-glufosinate hydrochloride with a propylene oxide in water to obtain corresponding acid; followed by treatment with ammonia and water to obtain aqueous solution of L-glufosinate ammonium.

In another embodiment, L-glufosinate hydrochloride is converted to corresponding L-glufosinate acid by treating the L-glufosinate hydrochloride with a base subsequently followed by step of separation/purification and then optional treatment with base and water.

In an embodiment, the base used is selected from inorganic base or organic base; the inorganic base is selected from alkali hydroxide, such as potassium hydroxide and sodium hydroxide or alkali metal carbonate such as, potassium carbonate, sodium carbonate, ammonium carbonate, potassium bicarbonate, sodium bicarbonate, or ammonia in aqueous or gaseous form. The organic base is selected from triethylamine, pyridine, triethylene diamine and N, N-dimethyl pyridine.

In an embodiment the base used is ammonia.

In an embodiment the base used is sodium hydroxide.

In a subsequent embodiment, said treatment of L-glufosinate hydrochloride with base is carried out at a temperature ranging from 20° C. to 50° C., preferably at temperature ranging from 25° C. to 35° C.

In an embodiment, said treatment of L-glufosinate hydrochloride with base is carried out in presence of water to obtain an aqueous solution comprising L-glufosinate acid.

In an embodiment, the aqueous solution comprising L-glufosinate acid is subjected to a step of separation/purification.

In an embodiment, the aqueous solution comprising L-glufosinate acid, may further comprise salts of L-glufosinate.

The salts of L-glufosinate includes, but not limited to, ammonium salt or sodium salt.

In another embodiment, the aqueous solution comprising L-glufosinate acid and/or salts of L-glufosinate is subjected to a step of separation/purification.

In another embodiment, the aqueous solution comprising L-glufosinate is taken as such or diluted with water and then subjected to separation/purification by way of filtration.

The by-products formed in said step (ii) are removed by filtration, such as gravity filtration or pressure filtration.

In an embodiment, the filtration is carried out as a pressure filtration by using a nanomembrane wherein the aqueous solution comprising L-glufosinate acid is allowed to pass through the membrane to separate out the inorganic insoluble.

In an embodiment, the membrane used may be formed from any polymeric material which provides separating layer capable of fractionating the L-glufosinate content or separating the desired glufosinate from inorganic salts.

In an embodiment, the polymeric material used for the nanomembrane is made from natural or synthetic polymers selected from, but not limited to, polycarbonate, polyethylene, polypropylene, polytetrafluoroethylene (PTFE), polyvinylidene difluoride (PVDF), polysulfone, polyether Sulfone, polyacrylonitrile, polyamide, polyimide, polyamideimide, polyetherimide, cellulose acetate, cellulose nitrate polyaniline, polypyrrole, polyetheretherketone (PEEK), polybenzimidazole, polyester, vinyl polymer such as polyvinyl alcohol, polydimethylsiloxane or mixtures thereof.

In another embodiment, the aqueous solution comprising L-glufosinate acid is subjected to filtration through a nanomembrane one or more times to effectively remove insoluble inorganics and to obtain a concentrate; concentrate was then treated with base and water to obtain aqueous solution containing at least 15% of L-glufosinate salt.

In an embodiment, the filtration of the aqueous solution is carried out at temperature ranging from 20° C. to 50° C., preferably at temperature ranging from 35° C. to 45° C.

In another embodiment water is optionally removed by way of distillation to get at least 15% aqueous solution of L-glufosinate salt.

In another embodiment, the L-glufosinate acid obtained in step ii) is treated with base and water at temperature ranging from 25° C. to 30° C.

In an embodiment the pH of the aqueous solution of L-glufosinate or salts thereof after base treatment is between 5 to 9.

In an embodiment, present invention provides a process for preparation of an aqueous solution of L-glufosinate ammonium, comprising the steps of:
i) obtaining L-glufosinate hydrochloride having purity of at least 90%; comprising steps of:
   a. hydrolysis of ethyl (2S)-2-[(ethoxy carbonyl)amino]-4-[ethoxy(methyl)phosphoryl]butanoate in presence of hydrochloric acid to obtain crude L-glufosinate hydrochloride of Formula (Ia) having purity of not more than 85%,
   b. treating crude L-glufosinate hydrochloride obtained in step a) with water, alcohol or mixture thereof at 40° C. to 80° C. to obtain L-glufosinate hydrochloride having purity of at least 90%,
ii) converting said hydrochloride to aqueous solution of L-glufosinate ammonium;
comprising steps of:
   treating L-glufosinate hydrochloride with ammonia followed by a step of separation/purification by way of filtration; wherein filtration is carried out by using a nanomembrane.

In an embodiment, aqueous solution or MUP solution contains at least 15% L-glufosinate or salts thereof is substantially free of impurities.

In an embodiment, aqueous solution or MUP solution contains at least 15% L-glufosinate or salts thereof comprises L-glufosinate ammonium.

In an embodiment, aqueous solution or MUP solution contains at least 30% L-glufosinate or salts thereof comprises L-glufosinate ammonium.

In an embodiment, aqueous solution or MUP solution contains at least 50% L-glufosinate or salts thereof comprises L-glufosinate ammonium.

In another embodiment, the present invention provides the process for preparation of an aqueous solution of L-glufosinate ammonium comprising steps of.
i. obtaining L-glufosinate hydrochloride having purity of at least 90%;
ii. converting said hydrochloride to L-glufosinate acid followed by treatment with ammonia to obtain aqueous solution containing at least 15% of L-glufosinate ammonium;
   wherein said aqueous solution of L-glufosinate ammonium is substantially free of impurities.

In another embodiment, the present invention provides a process for preparation of an aqueous solution of L-glufosinate sodium, comprising the steps of;
i) obtaining L-glufosinate hydrochloride having purity of at least 90%; comprising steps of.
   a. hydrolysis of ethyl (2S)-2-[(ethoxy carbonyl)amino]-4-[ethoxy(methyl)phosphoryl]butanoate in presence of hydrochloric acid to obtain crude L-glufosinate hydrochloride of Formula (Ia) having purity of not more than 85%,
   b. treating crude L-glufosinate hydrochloride obtained in step a) with water, alcohol or mixture thereof at 40° C. to 80° C. to obtain L-glufosinate hydrochloride having purity of at least 90%,
ii) converting said hydrochloride to aqueous solution of L-glufosinate sodium;
comprising steps of:
   treating L-glufosinate hydrochloride with sodium hydroxide followed by a step of separation/purification by way of filtration; wherein filtration is carried out by using a nanomembrane.

In another embodiment, the present invention provides the process for preparation of an aqueous solution of L-glufosinate sodium salt comprising steps of:
i. obtaining L-glufosinate hydrochloride having purity of at least 90%;
ii. converting said hydrochloride to L-glufosinate acid followed by treatment with sodium hydroxide to obtain aqueous solution containing at least 15% of L-glufosinate sodium salt;
   wherein said aqueous solution of L-glufosinate sodium salt is substantially free of impurities.

In another embodiment, there is provided use of an aqueous solution of L-glufosinate salt prepared according to the present invention for the preparation of an agrochemical composition.

In yet another embodiment of the present invention, there is provided an agrochemical composition comprising an aqueous solution of L-glufosinate salt prepared according to the present invention and at least one agrochemically acceptable excipient.

In another embodiment, the agrochemically acceptable excipient is selected from any one or a combination of adjuvants, co-solvents, surfactants, dispersants, emulsifiers, thickeners, antifreeze agents, biocides, anti-foam agents, stabilizers, wetting agents, or a mixture thereof.

In accordance with the above embodiment, surfactants comprises of non-ionic, anionic and cationic surfactants.

In an embodiment, nonionic surfactants are selected from poly arylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C₈-C₂₂ alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono- and diesters of ethylene glycol, and mixtures thereof.

In an embodiment, non-limiting examples of anionic surfactants include one or combination of alkyl ether phosphates, alpha olefin sulfonates, alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or diphosphate esters of polyalkoxylated alkyl alcohols or alkylphenols, mono- or disulfosuccinate esters of C₁₂-C₁₅ alkanols or polyalkoxylated C₁₂-C₁₅ alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-N-oleoyltaurate Na salt, polyoxy alkylene alkylphenol carboxylates, polyoxy alkylene alcohol carboxylates, alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates, and phosphated alkyl phenol ethoxylates.

In another embodiment, cationic surfactants include, but are not limited to, alkanol amides of C₈-C₁₈ fatty acids and C₈-C₁₈ fatty amine polyalkoxylates, C₁₀-C₁₈ alkyldimethylbenzylammonium chlorides, coconut alkyldimethylaminoacetic acids, and phosphate esters of C₈-C₁₈ fatty amine polyalkoxylates.

In another embodiment, exemplary antifreeze agent(s) include, but are not limited to, ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like.

Emulsifiers, which can be used in the present invention by person skilled in the art, include various non-ionic, anionic, cationic and amphoteric emulsifiers, or a blend of two or more emulsifiers. Examples of nonionic emulsifiers useful in preparing emulsifiable concentrates, for example, include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene.

Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers, and salts of phosphated polyglycol ether.

In another embodiment, present invention provides a process for preparing an agrochemical composition comprising an aqueous solution of L-glufosinate salt and at least one agrochemically acceptable excipient,
the process comprising:
   i. preparing an aqueous solution containing at least 15% of L-glufosinate salt according to the present invention.
   ii. adding at least one agrochemical acceptable excipient in the aqueous solution of step (i),
   iii. homogenizing the mixture obtained in step (ii) to get said agrochemical composition.

In a subsequent embodiment, said mixture obtained in step (ii) is stirred for 100-500 minutes get homogenized clear solution.

In another embodiment, homogenizing the mixture in step (iii) is carried out at 20-70° C.

In another embodiment, homogenizing the mixture in step (iii) is carried out at 20-50° C.

### EXAMPLES

The preferred embodiments of the present invention are illustrated by way of examples given below. However, the scope of the present invention is not to be construed as limited by the examples.

### Analytical Method Details:

Samples were analyzed on high performance liquid chromatograph (HPLC) with Photo diode array detector (PDA) using Inertsil ph-3 (250×4.6) 5 Micro meter.

### Example 1

### Preparation of L-Glufosinate Acid Hydrochloride:

Ethyl (2S)-2-[(ethoxy carbonyl)amino]-4-[ethoxy(methyl)phosphoryl]butanoate (404 g; having purity of 76.5%, 1 mole) was charged in the reactor having 30% conc. HCl (1950 g) at 25° C. to 30° C. The reaction mixture was heated to 120° C. and maintained for 16 to 18 hours till the completion of the reaction. The mixture was subjected to distillation under reduced pressure at 50° C. to 70° C. Ethanol was added to this concentrated mass. The slurry thus obtained, was further cooled and filtered to get wet cake of L-Glufosinate acid hydrochloride 222 g (Purity—92.51%). The wet cake was used as such for next step.

### Example 2

### Preparation of Aqueous Solution of L-Glufosinate Ammonium—Method 1:

Wet cake of L-glufosinate hydrochloride (222 g) as obtained in example 1 was charged in ethanol (530 ml) under stirring at 25° C. to 30° C. To this solution propylene oxide (80 g; 1.36 moles) was added at 0° C. to 5° C. in 30 minutes. The reaction mass was stirred at room temperature till the completion of the reaction. Ethanol along with other volatile by-products formed during the reaction was distilled out from the reaction mixture under reduced pressure. To concentrated mass comprising L-glufosinate, water was added at 25° C. to 30° C. and the pH of the solution was adjusted at 5 to 7 by using ammonia. The resulting solution was taken for distilling out water under reduced pressure to obtain 52.91% aqueous solution of L-Glufosinate ammonium (315.5 g).

### Example 3

### Preparation of Aqueous Solution of L-Glufosinate Ammonium—Method 1a:

Wet cake of L-glufosinate hydrochloride (233 g) prepared by the process of example 1 was charged in water (630 ml) under stirring at 25° C. to 30° C. To this solution propylene oxide (80 g; 1.36 moles) was added at 0° C. to 5° C. in 30 minutes. The reaction mass was stirred at room temperature till the completion of the reaction. Water along with other volatile by-products formed during the reaction was distilled out from the reaction mixture under reduced pressure. To the concentrated mass comprising L-glufosinate, fresh lot of water was added at 25° C. to 30° C. and the pH of the solution was adjusted at 5 to 7 by using ammonia. The resulting solution was taken for distilling out water under reduced pressure so as to get 54.54% aqueous solution of L-Glufosinate ammonium (335 g).

### Example 4

### Preparation of Aqueous Solution of L-Glufosinate Ammonium—Method 2:

Wet cake of L-glufosinate hydrochloride (231 g) prepared by following the process of example 1 was charged in water under stirring at 25° C. to 30° C. pH of this aqueous solution was adjusted at 5 to 7 using ammonia and the solution was filtered. The volume (4500 ml) was adjusted by adding water to the filtered solution and used as such for purification. The solution was passed through nano membrane which comprised of D-Series Thin film membrane to get Permeate (2650 g) and Concentrate (1760 g). Water was distilled out under reduced pressure from the concentrate to obtain 53.34% aqueous solution of L-Glufosinate ammonium (336 g).

### Example 5

### Preparation of Aqueous Solution of L-Glufosinate Sodium

Wet cake of L-glufosinate hydrochloride (174 g) prepared by following the process of example 1 was charged in water under stirring at 25° C. to 30° C. The pH of the aqueous solution was adjusted at 5 to 8 using 45% Sodium Hydroxide solution (69 g) and the solution was filtered. The volume (4500 ml) was adjusted by adding water to the filtered solution and used as such for purification. The solution was passed through nano membrane which comprised of D-Series Thin film membrane to get Permeate (2650 g) and Concentrate (1760 g). Water was distilled out under reduced pressure from the concentrate thus obtained, so as to get 51.39% aqueous solution of L-Glufosinate sodium (293 g).

### Formulation Examples

Below formulation examples are for exemplary purposes wherein the formulation comprises 50 to 60% aqueous solution of L-glufosinate ammonium prepared according to example 2 to 4 of the present invention and excipients.

A soluble liquid formulations (SL) comprising L-glufosinate ammonium prepared according to the present invention are provided in below examples and can be modified, altered by person skilled within the scope of the present invention

| | Composition (% |
|---|---|
| Ingredients | w/w) |
| About 50% Aq. Solution of L- | 37.4 |
| glufosinate ammonium | |
| Propylene Glycol | 13.5 |
| Diethylene glycol | 5 |
| Alkyl polyglucoside | 20 |
| Alpha olefin sulfonate | 13 |
| Alkyl ether phosphate | 2.5 |
| Water | Q.S. |
| Total | 100 |

| | Composition (% |
|---|---|
| Ingredients | w/w) |
| About 50% Aq. Solution of L- | 37.4 |
| glufosinate ammonium | |
| Propylene Glycol | 7.50 |
| Butyl cellosolve | 1.50 |
| C₁₀-C₁₆ alkyl amine oxide | 33 |
| Water | Q.S. |
| Total | 100 |

We claim:

1. A process for obtaining L-glufosinate acid addition salt having purity of at least 90%, comprising treating crude L-glufosinate acid addition salt with water, alcohol or mixtures thereof.

2. The process as claimed in claim 1, wherein said acid addition salt is selected from L-glufosinate hydrochloride, L-glufosinate hydrobromide, L-glufosinate phosphate, L-glufosinate sulphate or L-glufosinate acetate.

3. The process as claimed in claim 1, wherein purity of said crude L-glufosinate acid addition salt is not more than 85%.

4. The process as claimed in claim 1, wherein said alcohol is selected from the group comprising of methanol, ethanol, n-propanol, isopropanol, n-butanol or tertiary butanol.

5. The process as claimed in claim 1, wherein crude L-glufosinate acid addition salt is prepared by hydrolysis of compound of Formula (II) in presence of an acid, to give L-glufosinate acid addition salt, 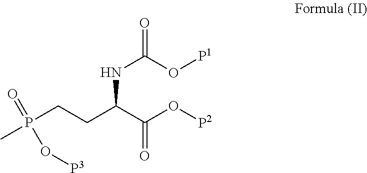
wherein, P¹ selected from group comprising of substituted or unsubstituted C₁ to C₁₀ alky group;
P² is selected from group comprising of substituted or unsubstituted C₁ to C₁₀ alkyl group; and
P³ is selected from hydrogen; substituted or unsubstituted C₁ to C₁₀ alkyl group.

6. The process as claimed in claim 5, wherein compound of Formula (II) is (2S)-2-[(ethoxy carbonyl)amino]-4-[ethoxy(methyl)phosphoryl]butanoate.

7. A process for preparation of an aqueous solution of L-glufosinate salt, comprising the steps of:
i. obtaining L-glufosinate hydrochloride having purity of at least 90%, and
ii. converting said hydrochloride to aqueous solution containing at least 15% of L-glufosinate salt by treatment with a base.

8. The process as claimed in claim 7, wherein said L-glufosinate salt is L-glufosinate ammonium or L-glufosinate sodium.

9. The process as claimed in claim 7, wherein the base used in step (ii) is selected from the group comprising of alkali hydroxide; alkali metal carbonate or bicarbonate; ammonia.

10. The process as claimed in claim 7, wherein said treatment of L-glufosinate hydrochloride with base is carried out at a temperature ranging from 20° C. to 50° C.

11. The process as claimed in claim 7, wherein step (ii) further comprises a step of separation/purification by way of filtration; and wherein filtration is carried out by using a nanomembrane.

12. The process as claimed in claim 7, wherein in step (ii), L-glufosinate hydrochloride is first converted to corresponding acid by treating with an alkylene oxide; followed by treatment with base to obtain said aqueous solution of L-glufosinate salt.

13. The process as claimed in claim 12, wherein said alkylene oxide is selected from ethylene oxide, propylene oxide, epichlorohydrin or 1,2-Epoxycyclohexane.

14. The process as claimed in claim 12, wherein said alkylene oxide treatment is carried out in water or alcohol.

15. Use of the aqueous solution of L-glufosinate salt according to claim 7 for the preparation of an agrochemical composition.

16. An agrochemical composition comprising an aqueous solution of L-glufosinate salt according to claim 7 and at least one agrochemically acceptable excipient.

17. A process for preparing an agrochemical composition comprising an aqueous solution of L-glufosinate salt and at least one agrochemically acceptable excipient,
the process comprising:
i. preparing an aqueous solution containing at least 15% of L-glufosinate salt according to claim 7,
ii. adding at least one agrochemical acceptable excipient in the aqueous solution of step (i),
iii. homogenizing the mixture obtained in step (ii) to get said agrochemical composition.

18. A process for preparation of an aqueous solution of L-glufosinate salt, comprising the steps of,
i) obtaining L-glufosinate hydrochloride having purity of at least 90%; comprising steps of:
a. hydrolysis of ethyl (2S)-2-[(ethoxy carbonyl)amino]-4-[ethoxy(methyl)phosphoryl]butanoate in presence of hydrochloric acid to obtain crude L-glufosinate hydrochloride of Formula (Ia) having purity of not more than 85%,
b. treating crude L-glufosinate hydrochloride obtained in step a) with water, alcohol or mixture thereof at 40° C. to 80° C. to obtain L-glufosinate hydrochloride having purity of at least 90%,
ii) converting said hydrochloride to aqueous solution of L-glufosinate salt; comprising steps of:
treating L-glufosinate hydrochloride with an alkylene oxide to obtain corresponding acid; followed by treatment with base and water to obtain aqueous solution of L-glufosinate salt.

19. The process as claimed in claim 18, wherein step ii) of converting L-glufosinate hydrochloride to aqueous solution of L-glufosinate salt comprises treating L-glufosinate hydrochloride with a base followed by a step of separation/purification by way of filtration; wherein filtration is carried out by using a nanomembrane.
